(19) United States
(12) Patent Application Publication
(10) Pub. No.: US 2025/0091129 A1
(43) Pub. Date: Mar. 20, 2025

(54) SPLIT-DIE PRESS TOOL

(71) Applicant: AB SANDVIK COROMANT, Sandviken (SE)

(72) Inventor: Per LINDSKOG, Sandviken (SE)

(21) Appl. No.: 18/576,798

(22) PCT Filed: Jun. 22, 2022
(86) PCT No.: PCT/EP2022/066996

§ 371 Date: Jan. 5, 2024

(30) Foreign Application Priority Data
Jul. 6, 2021 (EP) 21183888.3

(51) Int. Cl. B22F 3/03; B22F 5/00; B30B 11/00; B30B 15/02

(52) U.S. Cl. CPC B22F 3/03; B30B 11/007; B30B 15/022; B22F 2003/033; B22F 2005/001

(57) ABSTRACT

A split-die press tool for forming, by compressing a powder, a green body for a double-sided and double positive cutting insert for metal cutting. The tool includes a die with at least two die sections having a punch tunnel formed therebetween, an upper punch unit and a lower punch unit. When the lower punch unit is in a distal position a front end periphery of the lower punch unit is at a first expansion level corresponding to a maximal downward vertical decompression expansion of the green body to be formed. The punch tunnel has a first side surface portion on at least one of the die sections that has a vertical extension downward from the first pressing level to the first expansion level and is inclined downward and away from the pressing axis by an angle β of at least the angle α of an adjacent inclined lower surface of the green body.

### TECHNICAL FIELD

The present invention relates to a split-die press tool for forming, by compressing a powder, a green body for a double-sided positive cutting insert.

### BACKGROUND

Conventional cutting inserts typically comprise a body with a top surface, a bottom surface and a circumferential side surface. Between the top surface and the bottom surface there is a central plane. Conventional, cutting inserts of a type commonly called “double-sided cutting inserts”, have a top cutting edge at the intersection between the top surface and the side surface, and a bottom cutting edge at the intersection between the bottom surface and the side surface. Furthermore, such cutting inserts are indexable to present one of the cutting edges at a time for cutting operations.

One group of such double-sided cutting inserts are arranged to have a portion of the top surface and a portion of the bottom surface that are adjacent the top cutting edge and a portion of the bottom cutting edge, respectively, as chip surface. The portion of the side surface that is adjacent the top cutting edge and the portion of the side surface that is adjacent the bottom cutting edge then form a respective clearance surface. The clearance surface has a negative nominal clearance angle when it is inclined 90° relative the central plane, and, a positive nominal clearance angle when, from the associated cutting edge toward the central plane, it is inclined inward toward the centre of the cutting insert. A double-sided cutting insert is referred to as double positive when both the clearance surfaces thereof have a positive nominal clearance angle. In such double positive cutting inserts, the side surface typically has a waist at the central plane.

A conventional method for producing a cutting insert for metal cutting is to form a green body by compressing a powder in a press tool. The process of forming the green body in the press tool typically includes the steps of filling a press tunnel in the press tool with a powder, compressing the powder to form a green body in compressed state, and decompressing the compressed green body, wherein then green body expands. The expanded and relaxed green body is then removed from the press tool and usually thereafter subjected to additional process steps such as sintering, grinding and/or coating in order to form the final cutting insert.

When compressing a powder for forming a green body for a double-sided and double positive cutting insert, a split-die press tool with horizontally movable and separable die sections can be used. The press tool further comprises vertically movable upper and a lower punches. The side surface of a green body for forming a double-sided and double positive cutting insert normally has a similar shape as the side surface of the finished cutting insert, including being inclined inward toward the centre of the green body. When the powder is compressed to form the green body in a compressed state thereof, the lower punch is in an upper most position inside a press tunnel in the press tool. A press tunnel surface of a die section that is adjacent to the green body when the green body is in the compressed state, has an extension equal to the side surface of the green body. Thus, in case of a green body for a double-sided double positive cutting insert, the press tunnel surface is configured to follow the inclination of the side surface of the green body. Furthermore, the inclined surface of the press tunnel extends a vertical distance below a front end surface of the lower punch when the lower punch is in the upper most position. Thereby, the green body is able to expand downward when decompressing without risking to damage the bottom edge at the lower end of the inclined side surface.

A problem with split-die press tools of the above-mentioned kind is that during filling the press tool with powder for the green body, unwanted amounts of powder tend to leak out between the lower punch and the side surface of the die sections. Leakage of powder may affect operator health, damage the press tool or, due to local loss of material, cause shape deviations near the edge of the green body.

### SUMMARY

It is an object of the present invention to mitigate the shortcomings of the prior art and to provide a split-die press tool wherein powder leakage can be reduced. This object is achieved according to the invention by means of a split-die press tool according to claim 1.

The present invention relates to a split-die press tool for forming, by compressing a powder, a green body for a double-sided and double positive cutting insert for metal cutting, wherein the green body has a top edge, a bottom edge and a side surface connecting the top edge and the bottom edge, wherein the top edge is associated with an adjacent inclined upper surface in the side surface and the bottom edge is associated with an adjacent inclined lower surface in the side surface, which both respective inclined surfaces have a positive nominal angle α, comprising
a die with at least two die sections, wherein
   each die section is movably arranged along a horizontal axis to a respective proximal pressing position and to several respective distal positions, and wherein,
   when each die section is in their respective pressing position, the die sections form between them a punch tunnel extending along a vertical pressing axis,
an upper punch unit and a lower punch unit, which
   both have a front end with a circumferential front end periphery, and both are arranged in the punch tunnel with their front ends facing each other, and which
   both are movably arranged in the punch tunnel along the pressing axis to a respective proximal pressing position and to several respective distal positions,
      wherein,
when the die sections, the lower punch unit and the upper punch unit are in their respective pressing positions, the front end periphery of the lower punch unit is at a first pressing level, and a compression space corresponding to a compressed state of the green body to be formed is formed in the punch tunnel,
when the lower punch unit is in a distal position in form of a decompression position, the front end periphery of the lower punch unit is at a first expansion level corresponding to a maximal downward vertical decompression expansion of the green body to be formed, and wherein
the punch tunnel comprises a first side surface portion located on at least one of the die sections, which first side surface portion has a vertical extension downward from the first pressing level to the first expansion level,
   and wherein
the first side surface portion, as seen in a vertical cross section of the punch tunnel, is inclined downward and away from the pressing axis by an angle β of at least the angle α of an adjacent inclined lower surface of the green body to be formed, and
the punch tunnel comprises a second side surface portion located on the at least one of the die sections, which second side surface portion is vertically aligned with the first side surface portion and has a vertical extension downward from the first expansion level to a first restraining level, and at which first restraining level a horizontal distance to the adjacent front end periphery of the lower punch unit is less than at the first expansion level.

Thus, the first side surface portion in the punch tunnel is inclined downward and away from the pressing axis by an angle β. The angle β is at least the angle α of the adjacent lower inclined surface of a green body to be formed in the split-die tool. Furthermore, the first side surface portion has a vertical extension from the first pressing level, which is where the front end periphery of the lower punch unit is located when it is in the pressing position, to the first expansion level, which is at a distance below the first pressing level corresponding to the maximal downward vertical expansion of the green body during decompression. Due to such inclination and vertical extension of the first side surface portion, a green body, after having been compressed to a compressed state in the tool, can expand during decompression without damaging the bottom edge or the therewith associated inclined lower surface through harmful contact with the side surface in the punch tunnel.

The second side surface portion is vertically aligned with the first side surface portion and extends from the first expansion level downward to a first restraining level. Thanks to the horizontal distance between the second side surface portion and the adjacent front end periphery of the lower punch unit at the first restraining level being less than at the first expansion level, a horizontal gap where powder can leak during filling is narrowed from the first expansion level to the first restraining level. Thus, at least some of the powder escaping past the first expansion level can be stopped at the first restraining level. Thereby, unwanted leakage of powder through a horizontal gap formed between the lower end of the first side surface portion at the first expansion level and the punch unit during filling of the tool can be prevented by the inventive second side surface portion.

The split-die press tool according to the present invention is suitable for forming a green body by compressing a powder, such as cermet, cemented carbide powder or a metallurgical powder. During forming of the green body in the split-die press tool, the powder is compressed to form the green body, which assumes a compressed state after the intended maximal pressure has been applied. In the compressed state, the green body has the smallest dimensions. As pressure is removed, the green body expands. When decompression is complete, the green body is no longer in compressed state, and has experienced maximal decompression expansion. After the green body has been formed and removed from the press tool, it can be subjected to other treatments such as sintering, grinding, edge treatment and/or coating. A cutting insert can be obtained from the green body and be used for machining, for example metal cutting. Examples of such cutting inserts are milling cutting inserts, turning cutting inserts and drilling cutting inserts.

The split-die press tool according to the present invention is suitable for forming a green body for a double-sided and double positive cutting insert for metal cutting. The green body typically comprises a top edge, a bottom edge and a side surface connecting the top edge and the bottom edge. In the finished cutting insert, these edges may constitute cutting edges. The top edge is associated with an adjacent inclined upper surface in the side surface and the bottom edge is associated with an adjacent inclined lower surface in the side surface. In the finished cutting insert, these inclined surfaces may constitute clearance surfaces. Both respective inclined surfaces have a positive nominal angle α for example 2-35°. In the finished cutting insert, the positive nominal angle α corresponds to a positive nominal clearance angle.

As seen in a vertical cross section through the top edge, the inclined upper surface extends downward and inward toward the centre of the cutting insert. As seen in a vertical cross section through the bottom edge, the inclined lower surface extends upward and inward toward the centre of the cutting insert. The cross sections constitute vertical planes that are parallel with a central vertical plane through the edge. Optionally, the side surface has a waist from which the inclined surfaces protrude outward ending with the respective edge.

Optionally, the green body has a round or a polygonal shape as seen in a top view, for example, square, rectangular, pentagonal or hexagonal shape. The green body may have an inclined upper and lower surface along the entire side surface, or portions thereof, for example at a few of the sides, such as along two sides of a green body with square or rectangular shape. Optionally, only a portion of the side surface of one or several sides of the green body has both the upper and a lower inclined surface.

The split-die press tool comprises a die having at least two movable die sections and two movable punch units. The die sections are movably in a direction that is perpendicular to the punch units.

When the split-die press tool is positioned for operation, the die sections are movably arranged in both directions of a horizontal axis, and the punch units are movably arranged in both directions of a vertical axis. For the purposes of this application, the vertical and horizontal directions, or terms like “up” “down”, “inward” and “outward” are used with reference to the operating position of the split-die press tool. A level of the split-die press tool corresponds a vertical position in the vertical cross section of the split-die press tool.

The split-die press tool may comprise any suitable number of die sections, for example two or four. Preferably, the die sections are organized circumferentially around a centre, wherein they are movable inward toward the centre, and outward, away from the centre. Thereby, a space in the centre in form of a punch tunnel is operable to decrease or increase. Optionally, each die section is individually movable, or movable synchronized with some or all of the die sections, for example synchronized with a die section on an opposite side of the centre. When a die section has been moved inward to a position where the punch tunnel has a size for pressing, that die section is in a proximal pressing position. The proximal pressing position is during operation the innermost position for each die section. Any position of a die section that is outward from the proximal pressing position is a distal position.

The punch units are movable along a vertical pressing axis. Optionally, each punch unit comprises a single punch or each punch unit is split vertically into several part punches. The part punches of a punch unit, for example, are concentrically arranged, form vertical sections that arranged around a centre or arranged as slices next to each other. Optionally, each punch unit is individually movable or movable synchronized with the other punch unit. For punch units comprising several part punches, each part punch may be individually movable or movable synchronized with some or all of the part punches. The punch units are arranged in the punch tunnel that is formed in the centre of the die sections, the upper punch unit coming in from above and lower punch unit from below. Thereby, their respective front ends face each other. When a punch unit has been moved inward to a position for exerting the intended maximal pressure on a green body to be formed, the punch unit is in a proximal pressing position. During operation, this is the innermost position for both punch units. Any upward position of the upper punch unit and any lower position of the lower punch unit is a distal position.

When all die sections and both punch units are in their respective proximal pressing positions, the space in the centre of the punch tunnel forms a compression space corresponding to the dimensions of the green body to be formed in the compressed state.

Each punch unit has a front end. In embodiments where the punch unit is comprised of several part punches, the front end is commonly formed by the front ends of all part punches. Preferably, each punch unit has a front end surface, which is located at the front end. The front end surface has a topography/geometry corresponding to the desired topography/geometry of the green body to be formed. The front end has a periphery, which is to be understood as the edge of the front end that is furthest away from the centre of the punch tunnel, or in other words, the edge closest to the die sections. Preferably, the periphery is also the outer edge of the front end surface and also the entire punch unit.

Optionally, each punch unit has a circumferential side surface extending downward from the end surface. Preferably, the circumferential side surface of the punch unit is vertical. Thereby, the punch unit will slide with guidance in a vertically straight part of the punch tunnel, and furthermore, the risk of leaking powder getting caught against the circumferential side surface is reduced.

The punch tunnel is formed around the space at the centre of the die sections and is radially outward limited by inwardly facing side surfaces of the die sections. These side surfaces comprise several side surface portions, which may differ in location, extension and/or inclination. Optionally, a side surface portion is located on a single die section or extends over several die sections. A side surface portion that extends over several die sections, may be a non-continuous surface that, when the die sections are in their distal positions, is divided by gaps between the die sections.

During operation, first and second side surface portions are circumferentially and vertically aligned with the side surface of the green body, and specifically, with an adjacent inclined lower surface in the side surface of the green body. The first side surface portion faces the adjacent inclined lower side surface of the green body, so that it contributes to the forming of the adjacent side surface of the green body during decompression.

The first and second side surface portions are vertically aligned, wherein the first side surface portion is vertically above and connected to the second side surface portion at the lower end thereof.

The horizontal distance from any one of the side surface portions of the punch tunnel, which are located on the at least one die section, to the adjacent front end periphery of the punch unit, is a distance measured in the horizontal direction, for example in the vertical cross section. The distance is measured horizontally also when the periphery is located at a different level. The horizontal distance at the first restraining level is less than at the first expansion level. According to an embodiment, the horizontal distance at the first restraining level is less than 50% of the distance at the first expansion level, preferably less than 25%. Preferably, the horizontal distance at the first restraining level is at most 20 μm, preferably at most 10 μm. Thereby it is advantageously ensured that high amounts of powder leakage is prevented.

According to an embodiment, the horizontal distance at the first restraining level is at least 0.1 μm, preferably at least 2 μm. Thereby the punch unit is able to slide without too much friction in the punch tunnel.

A vertical distance between two levels is a distance measured in the vertical direction, for example in the vertical cross section. According to an embodiment, the vertical distance from the first expansion level to the first restraining level is at most 1 mm, and preferably at most 0.5 mm. Thereby, a space between the lower punch unit and the second side surface portion is kept small. Since powder leakage is restrained at the first restraining level, the amount of powder that can leak past the first expansion level corresponds to the amount of powder that fits into this space located above the first restraining level. Thus, such limited vertical extension contributes advantageously to limiting powder leakage.

In a powder filling step during operation, the lower punch unit is lowered and a space above the lower punch unit in the punch tunnel is filled with powder. When in a later compression step the lower punch unit is operated to move upward, the front end of the lower punch carries the powder into the compression space. Surplus powder fills the space between the second side surface portion and lower punch. According to an embodiment, the vertical distance from the first expansion level to the first restraining level is at least 0.05 mm, and preferably at least 0.2 mm. Thereby, it is ensured that there is enough space for accommodating such surplus powder.

The maximal vertical downward decompressing expansion of a green body to be formed may be 0,5-3% of the total vertical extension (height) of the green body in compressed state. According to an embodiment, the vertical distance from the first pressing level to the first expansion level is at least 0.05 mm, preferably at least 0.1 mm. This accommodates for expansions of the most common green bodies for double-sided and double positive cutting inserts.

The first side surface portion, as seen in a vertical cross section of the punch tunnel, is inclined downward and away from the pressing axis by an angle β of at least the angle α of the adjacent inclined lower surface of a green body to be formed. Thus, in the vertical cross section, angles α and β are measured between the respective inclined surface and a vertical plane that is perpendicular to the plane of the vertical cross section. The same result is achieved when measuring in the vertical cross section between the surface in question and a projection of the vertical pressing axis. According to embodiments, the angle β is 2-35°, preferably 5-20°. This accommodates for the most commonly desired nominal clearance angles for double-sided and double positive cutting insert to be produced.

Optionally, the angle β is greater than the angle α, wherein the first side surface portion, as seen in the vertical cross section, may extend linearly or concavely. In embodiments with a curved first side surface portion, the angle β is to be measured as a tangent to the first side surface portion. Thereby, a safety margin is created such that the bottom edge of the green body to be formed is further protected from being damaged by contacting the first side surface portion during expansion.

According to an embodiment, the angle β is equal to the angle α. Thereby advantageously the green body to be formed is supported during decompression expansion.

According to an embodiment, the second side surface portion comprises an upper portion, which extends downward from the first expansion level to a first relieving level. Optionally, the upper portion extends in the same direction as the first side surface portion, has a larger inclination angle & or a slightly concave shape. Thereby, the bottom edge of the green body to be formed is further protected from being damaged by contacting the upper portion of the second side surface portion during expansion.

Optionally, a vertical distance from the first expansion level to the first relieving level is 0-0.5 mm, preferably 0.05 mm-0.2 mm.

According to an embodiment, the second side surface portion comprises a lower portion, which extends downward from the first relieving level to the first restraining level and, as seen in the vertical cross section of the punch tunnel, is inclined downward and toward the pressing axis by an angle γ of at least 5° and at most 45°. Thereby, it is ensured that any surplus powder initially caught between the lower second side surface portion and the adjacent side of the lower punch unit, will not get stuck. After a decompression step during operation, the lower punch is retracted and the sections are moved to distal positions, the surplus powder is released and can slide down over the lower surface portion.

Preferably, the lower portion of the second side surface portion, as seen in the vertical cross section, is shaped such that surplus powder can fall downward more easily. For example, a linear or curved shape, wherein a convex shape may be beneficial.

According to a preferred embodiment, all points on the first side surface portion and the second side surface portion that are below the expansion level have a horizontal distance to the adjacent front end periphery of the lower punch unit that is larger than at the restraining level.

According to an embodiment, when the lower punch unit is in a distal, retracted position in form of a filling position, the front end periphery of the lower punch unit is at a filling level, wherein the filling level is below the first restraining level. It is advantageous to design the split-die press tool with such a low filling position because it allows enough room for filling the powder with initially low density and still achieve a high compaction when moving the lower and upper punch units to their respective proximal pressing positions. It is also advantageous that all available space for leaked powder, which is the space above the first restraining level, is above the level of the filling position.

According to an embodiment, the punch tunnel comprises a bottom side surface portion located on the at least one of the die sections, which bottom side surface portion is vertically aligned with the second side surface portion and has a vertical extension from the first restraining level downward to the filling level. At each level between the first restraining level and the filling level, a horizontal distance from the bottom side surface portion to the adjacent front end periphery of the lower punch unit is the same. Thereby the lower punch unit is properly guided in the punch tunnel and all available space of leaked surplus powder is above the first restraining level.

Preferably, both the bottom side surface portion and an adjacent part of the circumferential side surface of the punch unit, as seen in the vertical cross section being linear and vertical.

According to an embodiment, side surface portions corresponding to the first and second side surface portions are arranged adjacent the upper punch unit. This is advantageous in preventing powder leaking upwards during compaction of the powder in a pressing step. According to an example embodiment,
when the upper punch unit is in the pressing position, the front end periphery of the upper punch unit is at a second pressing level,
when the upper punch unit is in a distal position in form of a decompression position, the front end periphery of the lower punch unit is at a second expansion level corresponding to a maximal upward vertical decompression expansion of the green body,
the punch tunnel comprises a third side surface portion located on at the at least one of the die sections, which third side surface portion is vertically aligned with the first and the second side surface portions and has a vertical extension upward from the second pressing level to the second expansion level,
the third side surface portion, as seen in the vertical cross section of the punch tunnel, is inclined upward and away from the pressing axis by an angle β of at least the angle α of the adjacent upper inclined surface of the green body to be formed,
the punch tunnel comprises a fourth side surface portion located on the at least one of the die sections, which fourth side surface portion is vertically aligned with the third side portion and has a vertical extension upward from the second expansion level to a second restraining level, and at which second restraining level a horizontal distance to the adjacent front end periphery of the upper punch unit is less than at the second expansion level.

Other embodiments have the first side surface portion and the second side surface portion and differently formed surfaces on the at least one die section at the upper punch unit.

Preferably, the third side surface portion is symmetrical to the first side surface portion, and the fourth side surface portion is symmetrical to the second side surface portion over a horizontal axis between the first pressing level and the second pressing level. The symmetry may be mirror symmetry or rational symmetry. A double-sided cutting insert, which is to be produced from the green body to be formed in the press tool, usually has a rotational symmetry. Thus, this embodiment advantageously is suitable for forming green bodies for such common cutting insert.

According to another aspect of the present invention, the split-die press tool as described above comprises a powder, which powder is pressable to the green body in compressed state, and which green body is decompressible to form the green body. Thus, the split die-press tool includes also the powder and the green body to be formed therefrom. The formed green body has a top edge, a bottom edge and a side surface connecting the top edge and the bottom edge, wherein the top edge is associated with an adjacent inclined upper surface in the side surface and the bottom edge is associated with an adjacent inclined lower surface in the side surface, which both respective inclined surfaces have a positive nominal angle α.

### BRIEF DESCRIPTION OF THE DRAWINGS

In the following, example embodiments will be described in greater detail and with reference to the accompanying drawings, in which:

FIG. 1 is a schematic view of a first embodiment of a split-die press tool, wherein two die sections, a an upper punch and a lower punch each are in a pressing position;

FIG. 2 is a schematic exploded view of the first embodiment of a split-die press tool;

FIG. 3 is a perspective view of a green body that has been formed in the split-die press tool according to the first embodiment;

FIG. 4 is a vertical cross section through the green body of FIG. 3, wherein the plane of the vertical cross section is a central vertical plane;

FIG. 5 is an enlarged cross sectional view of the split-die press tool according to the first embodiment when it is set to compress the powder to form the green body in a compressed state;

FIG. 6 is an enlarged cross sectional view corresponding to FIG. 5 of the split-die press tool according to the first embodiment when it is set to allow the green body to expand maximally downward during decompression;

FIG. 7 is a view corresponding to the view of FIG. 6 of a second embodiment of the split-die press tool;

FIGS. 8a-8d are cross sectional views of the split-die press tool representing showing the different positions of the die section and the punch units during a press cycle.

All the figures are schematic, not necessarily to scale, and generally only show parts which are necessary in order to elucidate the respective embodiments, whereas other parts may be omitted or merely suggested. Unless otherwise indicated, like reference numerals refer to like or corresponding parts in different figures.

### DETAILED DESCRIPTION

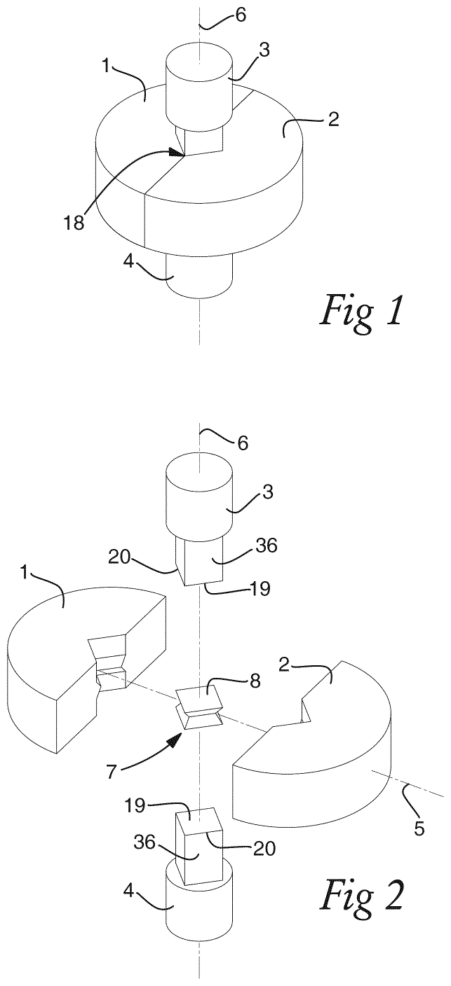

In FIGS. 1 and 2, the overall design of an embodiment of the split-die press tool according to the present invention is shown. The split-die press tool comprises two die sections 1, 2, an upper punch unit in form of a single upper punch 3 and a lower punch unit in form of a single lower punch 4.

Both die sections 1, 2 are movably arranged along a horizontal axis 5, wherein each is movable to a respective proximal pressing position, and to several respective distal positions. Specifically, the die sections 1, 2 are movable inward toward a centre 7, and outward away from the centre 7.

Both punches 3, 4 are movably arranged along a vertical pressing axis 6, wherein each is movable to a respective proximal pressing position, and to several respective distal positions. Specifically, the punches 3, 4 are movable toward each other and the centre 7, and outward away from each other and the centre 7.

In the example embodiment, both die sections 1, 2 and both punches 3, 4 are individually movable independent from the other die sections and punches.

The split-die press tool is operable to form a green body by compressing a powder, which in the present example embodiment is a cemented carbide powder. During operation, the powder is compressed to form a green body in a compressed state, which green body then is decompressed and allowed to expand into a final shape. In FIG. 2, a green body 8 that has been formed in the tool is shown, wherein the green body has the final shape. The green body 8 is later to be used in a process for producing a cutting insert for metal cutting.

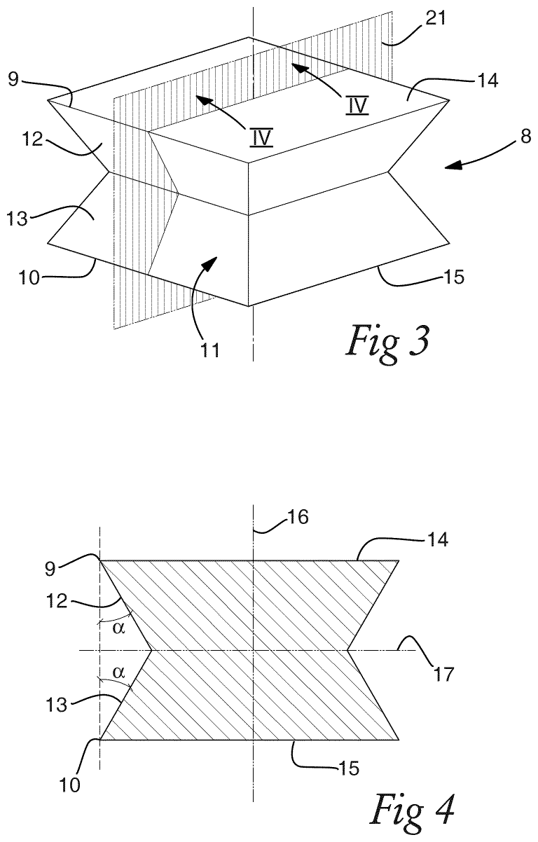

With reference to FIGS. 3 and 4, the green body 8 comprises a top surface 14, a bottom surface 15 and a circumferential side surface 11 connecting the top surface 14 and the bottom surface 15. At the intersection between the side surface 11 and the top surface 14, a top edge 9 is formed. At the intersection between the side surface 11 and the bottom surface 15, a bottom edge 10 is formed. The top edge 9 is associated with an adjacent inclined upper surface 12 in the side surface 11, and the bottom edge 10 is associated with an adjacent inclined lower surface 13 in the side surface. In FIG. 4, a vertical cross section through the top edge 9 and the bottom edge 10, which vertical cross section is a central vertical plane 21 is shown. The upper surface 12 extends downward and inward by an angle α, and the lower surface 13 extends upward and inward by an angle α. Both angles α constitute positive nominal angles that will form positive nominal clearance angles in the finished cutting insert. The finished cutting insert produced from the green body 8 will be double-sided and double positive. In the green body 8, the nominal angle α is the angle between the vertical plane 16 that is perpendicular to the plane of the vertical cross section according to the view of FIG. 4. In the first embodiment, the angle α is 15° Due to the inclined upper and lower surfaces 12, 13, the green body has a waist at a central horizontal plane 17.

When the die sections 1, 2 are in their respective pressing positions, they form a punch tunnel 18 between them, wherein the centre 7 is located at the centre of the punch tunnel 18. In FIG. 1, both die sections 1, 2 and both punches 3, 4 are in their respective proximal pressing positions and a compression space corresponding to the shape of the green body 8 in a compressed state is formed between them. By operating the die sections 1, 2 and/or the punch 3, 4 to move to a respective distal position, the space between the components 1, 2, 3, 4 increases in order to allow the green body 8 to expand and to be removed from the split-die press tool.

The upper punch 3 and the lower punch 4 each have a front end surface 19, which corresponds to the desired topography of the top surface 14 and the bottom surface 15 of the green body, respectively. Each front end surface 19 has a circumferential periphery 20. Depending on the position of the lower and upper punch 3, 4 in the punch tunnel, the respective periphery is located at corresponding different heights, or in other words levels, in the punch tunnel 18.

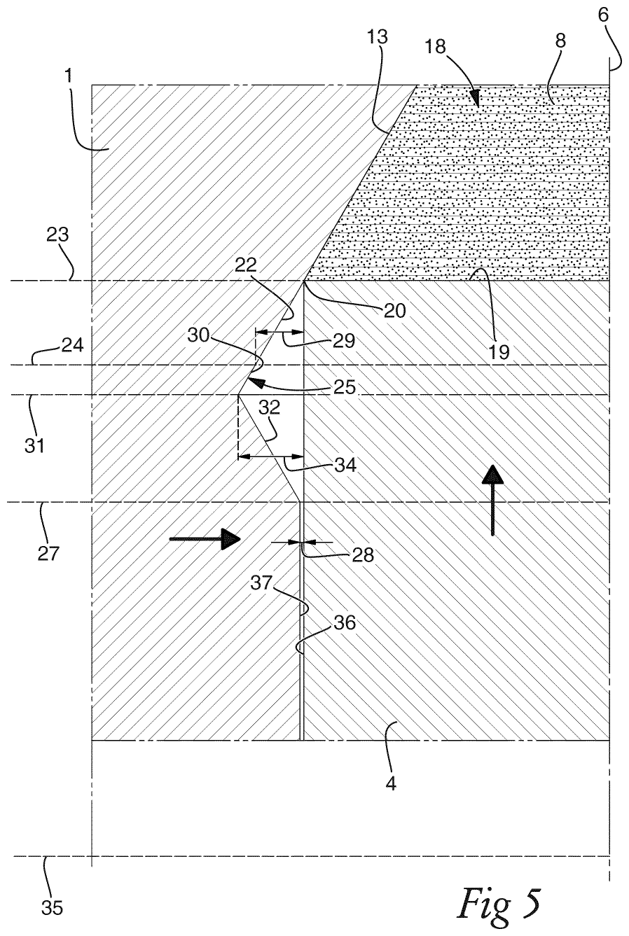

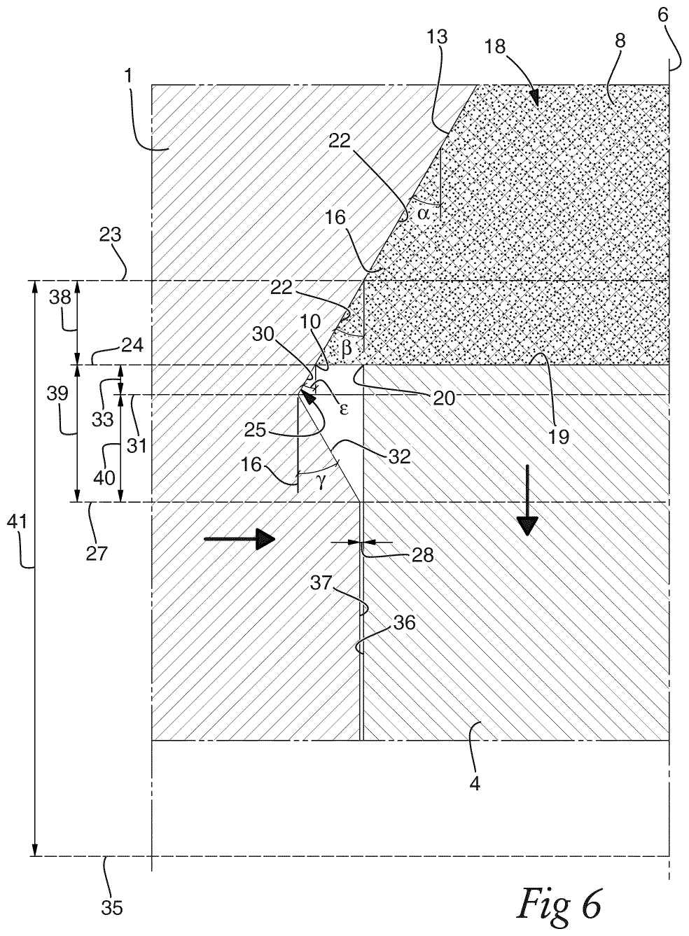

When the lower punch 4 is in a proximal pressing position as shown in FIG. 5, the front end periphery 20 thereof is at a first pressing level 23. The green body is in compressed state. When the lower punch 4 is in a distal decompression position as shown in FIG. 6, the front end periphery 20 thereof is at a first expansion level 24. A vertical distance 38 between the first pressing level 23 and the first expansion level 24 corresponds to the maximal downward vertical decompression expansion of the green body 8 after it is released from the compressed state. According to the first embodiment, the vertical distance 38 is 0.1 mm. Thus, the first expansion level 24 is below the first pressing level 23.

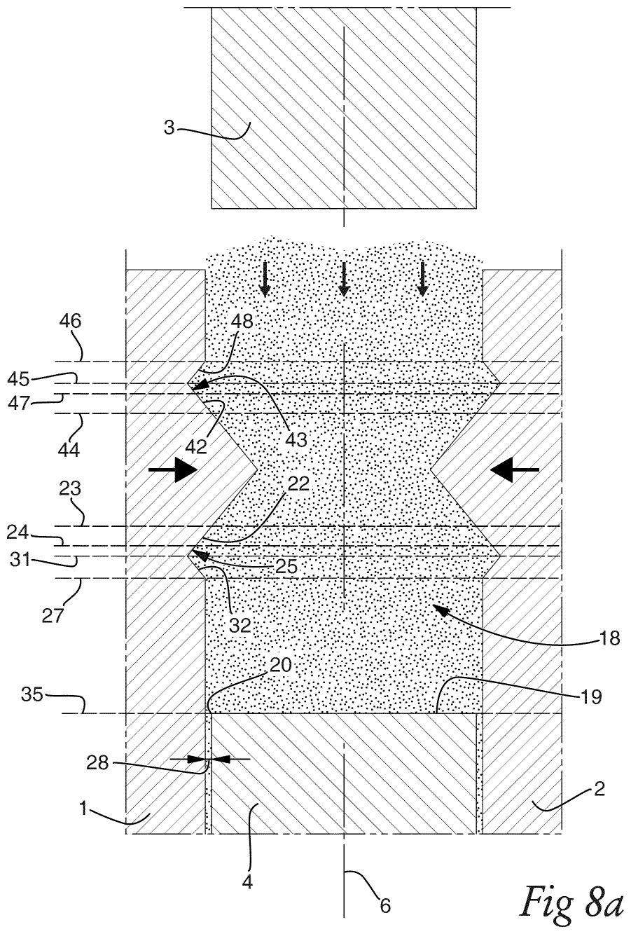

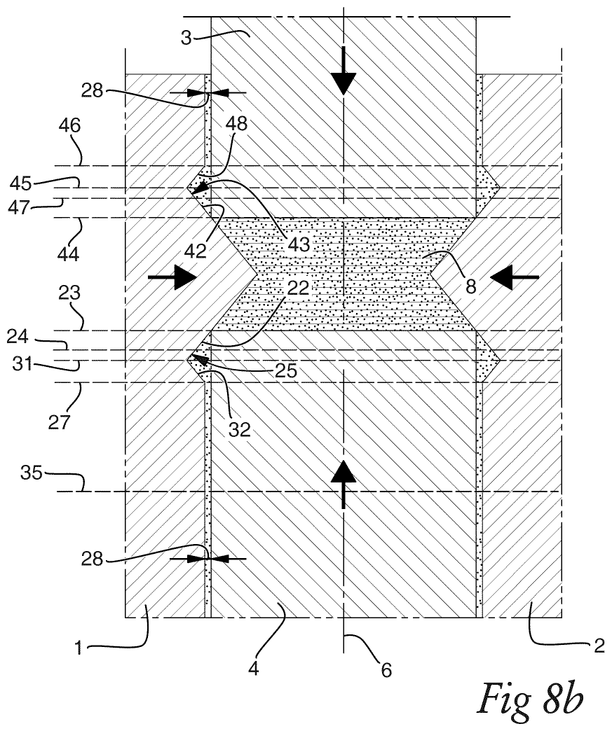

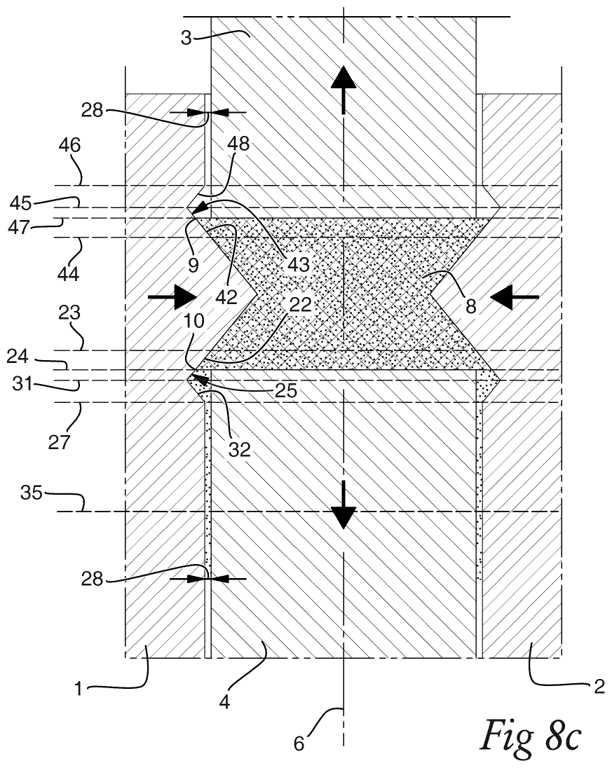

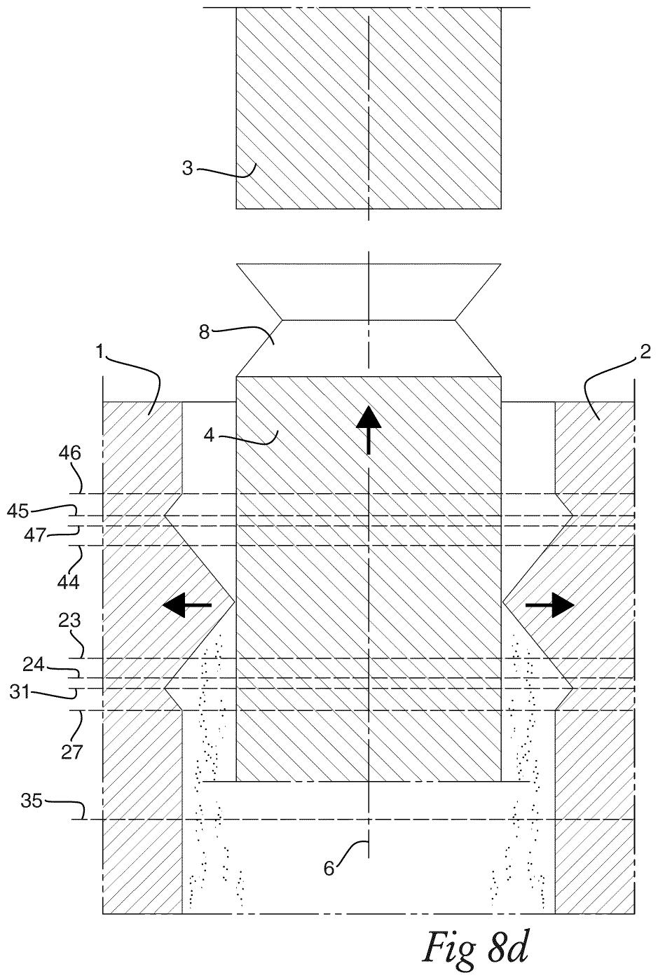

When during operation the split-die press tool is filled with powder, the upper punch 3 is moved to the side to expose the punch tunnel 18 and the lower punch 4 is in a distal filling position, c.f. FIG. 8a. When the lower punch 4 is in the filling position, the front end periphery 20 is at a filling level 35.

The upper and lower punches 3, 4 each have a circumferential side surface 36 extending rearward from the periphery 20 of the respective front end surface 19. According to the first embodiment, the circumferential side surfaces 36 each are vertical and, as seen in the cross sections of FIGS. 5, and 6, parallel with the pressing axis 6.

The punch tunnel 18 comprises a first side surface portion 22 which is located on the first die section 1, c.f. FIGS. 5 and 6. As can be derived from FIGS. 1 and 2, in the described first embodiment, also the second die section 2 comprises a corresponding first side surface portion 22. The first side surface portion 22 is located circumferentially aligned with the adjacent inclined lower surface 13 of the green body 8 and has a vertical extension downward from the first pressing level 23 to the first expansion level 24. The first side surface portion 22, from the first pressing level 23, is inclined downward and outward away from the pressing axis 6 by an angle β, c.f. FIG. 6. The angle β can also be measured as the angle between the first side surface portion 22 and the vertical plane 16 that is perpendicular to the plane of the vertical cross section according to the view of FIG. 6. In the shown first embodiment, the angle β is 15° and thus equal to the angle α. In other embodiments, the angle β is larger than the angle α.

The punch tunnel 18 further comprises a second side surface portion 25, which is also located on the first die section 1. In the first embodiment, also the second die section 2 comprises the second side surface portion 25. The second side surface portion 25 is vertically aligned with the first side surface portion 22 and, at the first expansion level 24, connected to a lower end thereof. The second side surface portion 25 has a vertical extension downward from the first expansion level 24 to a first restraining level 27. The first restraining level 27 is a level in the punch tunnel 18 that is below the first expansion level 24 and a vertical distance 39 from the first expansion level 24 to the first restraining level 27 is 0.19 mm. In the first embodiment, the total distance from the first pressing level 23 to the first restraining level 27 is the sum of the distance 38 and the distance 39, which in the first embodiment amounts to 0.29 mm.

Each point on the first and second side surface portion 22, 25, have a horizontal distance to the adjacent front end periphery 20 of the lower punch 4. This horizontal distance is a distance measured in the horizontal direction as seen in the cross section of FIG. 6 and is measured horizontally also when the periphery 20 is located at a different level.

With reference to FIG. 5, a horizontal distance 28 between the second side surface portion 25 and the front end periphery 20 of the lower punch 4 at the first restraining level 27 is less than a horizontal distance 29 between the second side surface portion 25 (or the first side surface portion 22) and the front end periphery 20 of the lower punch 4 at the first expansion level 24. When the first die section 1 is in the proximal pressing position as shown in FIG. 5, the horizontal distance 28 between the second side surface portion 25 and the front end periphery 20 of the lower punch 4 at the first restraining level 27 is 5 μm, and the horizontal distance 29 between the second side surface portion 25 (or the first side surface portion 22) and the front end periphery 20 of the lower punch 4 at the first expansion level 24 is determined by the maximal downward vertical decompression expansion and the angle β.

The second side surface portion 25 comprises an upper portion 30, which extends downward from the first expansion level 24 to a first relieving level 31. In the described first embodiment, the upper portion 30 extends in the same direction as the first side surface portion 22. The upper portion 30 is inclined downward and outward away from the pressing axis 6 by an angle E. The angle ε can be measured as the angle between the upper portion 30 and the vertical plane 16 that is perpendicular to the plane of the vertical cross section according to the view of FIG. 5. In the shown first embodiment, the angle ε is 15° and thus equal to the angles α and β.

The second side surface portion 25 further comprises a lower portion 32, which extends downward from the first relieving level 31 to the first restraining level 27. The lower portion 32 extends downward and toward the pressing axis 6 by an angle γ of 30°. The angle γ can be measured as the angle between the lower portion 32 and the vertical plane 16 that is perpendicular to the plane of the vertical cross section according to the view of FIG. 5.

According to the first embodiment, both the upper and lower portion 30, 32, as seen in the cross section of FIG. 6, have a linear extension. In the first embodiment, a vertical distance 33 between the first expansion level 24 and the first relieving level 31 is 0.1 mm and a vertical distance 40 from the first relieving level 31 to the first restraining level 27 is 0.09 mm. In the first embodiment, the total vertical distance 39 of the second side surface portion 25 from the first expansion level 24 to the first restraining level 27 is the sum of the distance 33 and the distance 40. When the first die section 1 is in the proximal pressing position as shown in FIG. 5, a horizontal distance 34 from the second side surface portion 25 at the first relieving level 31 to the front end periphery 20 of the lower punch 4 is governed by the angle E and the distance 33. This is the largest horizontal distance of the side surface of the punch tunnel 18 to the front end periphery 20 of the lower punch 4.

Finally, the punch tunnel 18 comprises a bottom side surface portion 37, which is also located on the first die section 1. In the first embodiment, also the second die section 2 comprises the bottom side surface portion 37. The bottom side surface portion 37 is vertically aligned with the first and second side surface portions 22, 25, and, at the first restraining level 27, connected to a lower end of the lower portion 32 of the second side surface portion 25. The bottom side surface portion 37 has a vertical extension downward from the first restraining level 27 to the filling level 35, wherein the bottom side surface portion 37 is vertical. The filling level 35 is below the first restraining level 27 and a vertical distance 41 from the first pressing level 23 to the filling level 35 is 50% of the total vertical extension (height) of the green body in compressed state. At each level between the first restraining level 27 and the filling level 35, a horizontal distance from the bottom side surface portion to the adjacent front end periphery 20 of the lower punch 4 is the same. Thereby, a gap between the circumferential side surface 36 of the lower punch 4 and the bottom side surface portion 37 is constant and equal to the horizontal distance 28 at the first restraining level 27. When the first die section 1 is in the proximal pressing position as shown in FIG. 5, the horizontal distance 28 and the gap is 5 μm.

The first die section of the first embodiment comprises a third side surface portion 42 and a fourth side surface portion 43. These side surface portions 42, 43 have locations and extensions with respect to the top edge 9 of the green body 8, the upper surface 12 of the green body 8 and the upper punch 3 that correspond to the locations and extensions of the first side surface portion 22 and the second side surface portion 25 with respect to the bottom edge 10 of the green body 8, the lower surface 13 of the green body 8 and the lower punch 4. Therefore, the third side surface 42 and the fourth side surface 43 will not be described in detail. In the first embodiment, the third side surface portion 42 is mirror symmetrical to first side surface portion 22, and the fourth side surface portion 43 is mirror symmetrical to the second side surface portion 25 over a central neutral horizontal plane at the waist of the green body in compressed state. However, in other embodiments, the third side surface portion 42 and the forth surface portion 43 have other symmetries over a horizontal axis in the neutral plane. Further other embodiments, have the first side surface portion 22 and the second side surface portion 25 only, and have different side surfaces at the upper punch.

With reference to FIGS. 8a-8f, positions and steps during a pressing cycle when the split-die press tool according to the first embodiment is operated is described.

In FIG. 8a, the first die section 1 and the second die section 2 are in their respective proximal pressing positions and form between them a punch tunnel 18. The upper punch 3 is removed from the punch tunnel 18 such that the punch tunnel is accessible from above. The lower punch 4 is in a distal position in form of a filling position, wherein the front end periphery 20 is at the filling level 35. A predetermined amount of a cemented carbide powder is filled into the punch tunnel 18. The powder flows downward in the punch tunnel 18 and fills a space in the punch tunnel 18 from the front end 19 of the lower punch 4 and upwards. As can be seen, the lower portion 32 of the second side surface portion 25 extends downward and toward the pressing axis 6. Thanks to this advantageous design, there is only a small gap between the periphery 20 of the lower punch 4 and the side surface of the first die section 1. The horizontal distance 28 of the gap is 5 μm when the first die section 1 and the second die section 2 are in their respective proximal pressing positions. Thanks to this narrow gap, only a minor amount of powder is able to leak past the front end periphery 20 of the lower punch 4.

In FIG. 8b, the split-die press tool has been operated to move the lower punch 4 to the proximal pressing position thereof, wherein the periphery 20 of the lower punch 4 is at the first pressing level 23. Furthermore, the split-die press tool has been operated to move upper punch 3 to the proximal pressing position thereof, wherein the periphery 20 of the upper punch 3 is at a second pressing level 44. Thereby, the powder is compressed and a green body 8 in compressed state is formed. Surplus powder fills the space between, on one hand, the first and second side surface portions 22, 25 and on the other hand, the lower punch 4. Similarly, surplus powder fills the space between, on one hand, the third and fourth side surface portions 42, 43, and on the other hand, the upper punch 3. Due to an upper portion 48 of the fourth side surface 43 (corresponding to lower portion 32 of the second side surface portion 25) extending upward and toward the pressing axis 6, there is only a small gap between the periphery 20 of the upper punch 3 and the side surface of the first die section 1. The horizontal distance 28 of the gap is 5 μm when the first die section 1 and the second die section 2 are in their respective proximal pressing positions. Thanks to this narrow gap, only a minor amount of powder is able to blow out past the front end periphery 20 of the upper punch 3 when the powder is compacted.

The split-die press tool according to the first embodiment further comprises a second relieving level 45 corresponding to the first relieving level 31, and a second restraining level 46 corresponding to the first restraining level 27.

After pressing, the lower punch 4 is operated to move to a distal position in form of the decompression position thereof, wherein the periphery 20 is at the first expansion level 24, c.f. FIG. 8c. At the same time, the upper punch 3 is operated to move to a distal position in form of the decompression position thereof, wherein the periphery 20 is at a second expansion level 47. The first die section 1 and the second die section 2 are still in their respective pressing positions. Thereby the green body 8 undergoes vertical decompression expansion, wherein it expands vertically. As shown in FIG. 6, the inclination angle β of the first side surface portion 22 and the third side surface portion 42 are equal to the inclination angle α of the lower adjacent surface 13 and the upper adjacent surface 12 of the green body 8, respectively. Thereby it is advantageously avoided that the bottom edge 10 and the top edge 9 are damaged by the side surfaces during decompression expansion. The first expansion level 24 and the second expansion level 47 correspond to the total maximal vertical decompression expansion of the green body 8. The vertical distance between the second expansion level 47 ad the first expansion level 24 corresponds to the vertical distance from the top edge 9 to the bottom surface 10 of the green body 8 in the final shape.

After decompression, the first die section 1 and the second die section 2 are operated to move further apart to a respective distal position for releasing the finished green body 8. Thereby the green body 8 undergoes horizontal decompression expansion, wherein it expands horizontally. With reference to FIG. 8d, surplus powder caught in the punch tunnel 18 can escape downward and be removed from the split-die press tool. This is facilitated by the inclination angle γ of the lower portion 32 of the second side surface portion 25 being 30°, c.f. FIG. 6. Finally, the upper punch 3 is removed from the punch tunnel 18 and the lower punch 4 with the finished green body 8 resting on top of the front end surface 19 is pushed out.

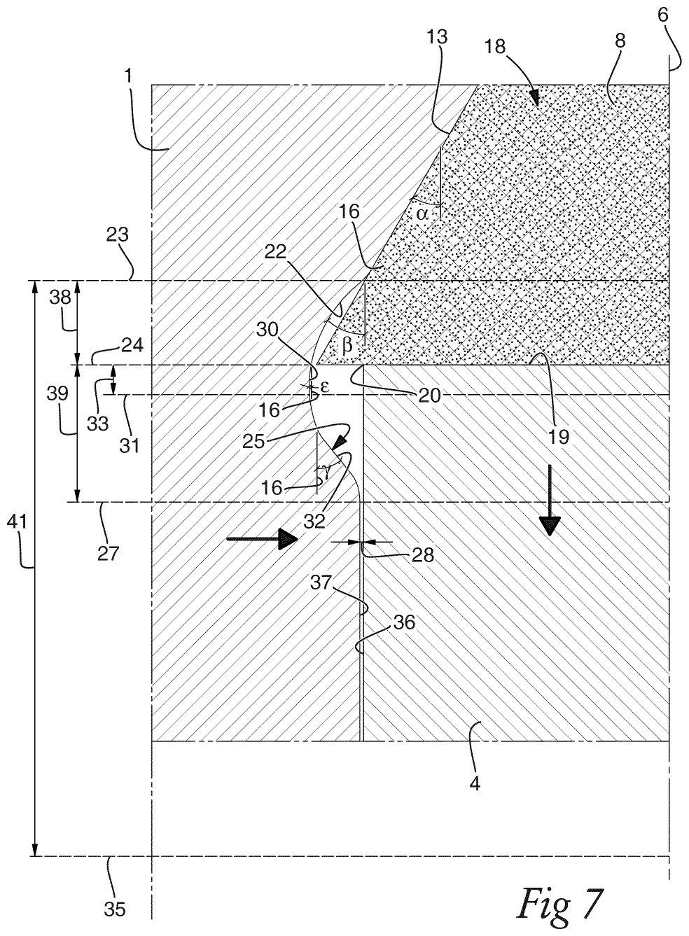

A second embodiment of the split die-press tool is shown in FIG. 7. The second embodiment differs from the first embodiment in the design of the first side surface portion 22 and the second side surface portion 25. The first side surface portion 22, the upper portion 30 and a major part the lower portion 32 of the second side surface portion 25 are concavely curved. The lowest part of the lower portion 32 of the second side surface portion 25 is convex in order to smoothly meet the vertical bottom side surface portion 37. This embodiment is advantageous in that the risk of powder getting stuck in sharp corners or pockets is even further reduced. The second embodiment is an example of an embodiment where the angle β is larger than the angle α.

The first die section of the second embodiment comprises a third side surface portion 42 and a fourth side surface portion 43. These side surface portions 42, 43 have locations and extensions with respect to the top edge 9 of the green body 8, the upper surface 12 of the green body 8 and the upper punch 3 that correspond to the locations and extensions of the first side surface portion 22 and the second side surface portion 25 with respect to the bottom edge of the green body 8, the lower surface 13 of the green body 8 and the lower punch 4. Therefore, these are not further described or shown in the Figures.

1. A split-die press tool for forming, by compressing a powder, a green body for a double-sided and double positive cutting insert for metal cutting, wherein the green body has a top edge, a bottom edge and a side surface connecting the top edge and the bottom edge, wherein the top edge is associated with an adjacent inclined upper surface in the side surface and the bottom edge is associated with an adjacent inclined lower surface in the side surface, which both respective inclined surfaces have a positive nominal angle α, the tool comprising
a die having at least two die sections, wherein each die section is movably arranged along a horizontal axis to a respective proximal pressing position and to several respective distal positions, and wherein, when each die section is in the respective pressing position, the die sections form therebetween a punch tunnel extending along a vertical pressing axis;
an upper punch unit and a lower punch unit, both the upper and lower punch unit having a front end with a circumferential front end periphery, and both upper and lower punch units being arranged in the punch tunnel with the respective front ends facing each other, and wherein both the upper and lower punch unit are movably arranged in the punch tunnel along the pressing axis to a respective proximal pressing position and to several respective distal positions, wherein, when the die sections, the lower punch unit and the upper punch unit are in their respective pressing positions, the front end periphery of the lower punch unit is at a first pressing level, and a compression space corresponding to a compressed state of the green body to be formed is formed in the punch tunnel, and when the lower punch unit is in a distal position in a form of a decompression position, the front end periphery of the lower punch unit is at a first expansion level corresponding to a maximal downward vertical decompression expansion of the green body to be formed, and wherein the punch tunnel includes a first side surface portion located on at least one of the die sections, wherein the first side surface portion has a vertical extension downward from the first pressing level to the first expansion level, and wherein the first side surface portion, as seen in a vertical cross section of the punch tunnel, is inclined downward and away from the pressing axis by an angle β of at least the angle α of an adjacent inclined lower surface of the green body to be formed, and the punch tunnel includes a second side surface portion located on the at least one of the die sections, which second side surface portion is vertically aligned with the first side surface portion and has a vertical extension downward from the first expansion level to a first restraining level, and at which first restraining level a horizontal distance to the adjacent front end periphery of the lower punch unit is less than at the first expansion level.

2. The split-die press tool as claimed in claim 1, wherein, when the at least one die section is in the pressing position, a horizontal distance to the adjacent front end periphery of the lower punch unit at the first restraining level is less than 20 μm.

3. The split-die press tool as claimed in claim 1, wherein the vertical distance from the first expansion level to the first restraining level is at most 1 mm.

4. The split-die press tool as claimed in claim 1, wherein the vertical distance from the first expansion level to the first restraining level is at least 0.05 mm.

5. The split-die press tool as claimed in claim 1, wherein the vertical distance from the first pressing level to the first expansion level is at least 0.1 mm.

6. The split-die press tool as claimed in claim 1, wherein the angle β is 2-35°.

7. The split-die press tool as claimed in claim 1, wherein the angle β of the first side surface portion is equal to the angle α.

8. The split-die press tool as claimed in claim 1, wherein the second side surface portion includes an upper portion, which extends in the same direction as the first side surface portion downward from the first expansion level to a first relieving level.

9. The split-die press tool as claimed in claim 8, wherein the second side surface portion includes a lower portion, which extends downward from the first relieving level to the first restraining level and, as seen in a vertical cross section of the punch tunnel (18), is inclined downward and toward the pressing axis by an angle γ of at least 5° at most 45°.

10. The split-die press tool as claimed in claim 1, wherein, when the lower punch unit is in a distal position in form of a filling position, the front end periphery of the lower punch unit is at a filling level, which is below the first restraining level.

11. The split-die press tool as claimed in claim 10, wherein the punch tunnel includes a bottom side surface portion located on the at least one of the die sections, which bottom side surface portion is vertically aligned with the second side surface portion and has a vertical extension from the first restraining level downward to the filling level, wherein, at each level between the first restraining level and the filling level, a horizontal distance from the bottom side surface portion to the adjacent front end periphery of the lower punch unit is the same.

12. The split-die press tool as claimed in claim 1, wherein, when the upper punch unit is in the pressing position, the front end periphery of the upper punch unit is at a second pressing level, and when the upper punch unit is in a distal position in form of a decompression position, the front end periphery of the upper punch unit is at a second expansion level corresponding to a maximal upward vertical decompression expansion of the green body, and the punch tunnel includes a third side surface portion located on at the at least one of the die sections, which third side surface portion, is vertically aligned with the first and the second side surface portions and has a vertical extension upward from the second pressing level to the second expansion level, the third side surface portion, as seen in the vertical cross section of the punch tunnel, being inclined upward and away from the pressing axis by angle β of at least the angle α of the adjacent upper inclined surface of the green body to be formed, and wherein the punch tunnel includes a fourth side surface portion located on the at least one of the die sections, which fourth side surface portion is vertically aligned with the third side portion and has a vertical extension upward from the second expansion level to a second restraining level, and at which second restraining level a horizontal distance to the adjacent front end periphery of the upper punch unit is less than at the second expansion level.

13. The split-die press tool as claimed in claim 12, wherein the third side surface portion is symmetrical to the first side surface portion, and the fourth side surface portion is symmetrical to the second side surface portion over a horizontal axis between the first pressing level and the second pressing level.

14. The split-die press tool as claimed in claim 1, further comprising a powder, wherein the powder is pressable to the green body in a compressed state, and which green body in the compressed state is decompressable to form the green body, wherein the green body has a top edge, a bottom edge and a side surface connecting the top edge and the bottom edge, and wherein the top edge is associated with an adjacent inclined upper surface in the side surface and the bottom edge is associated with an adjacent inclined lower surface in the side surface, which both respective inclined surfaces have a positive nominal angle α.
